(19) United States
(12) Patent Application Publication
(10) Pub. No.: US 2022/0053779 A1
(43) Pub. Date: Feb. 24, 2022

(54) METHODS AND SYSTEMS FOR MASS PRODUCING BREAD STICKS

(71) Applicant: DOOR COUNTY BAKERY, Sister Bay, WI (US)

(72) Inventor: Donaldo THOMPSON, Sister Bay, WI (US)

(21) Appl. No.: 17/407,300

(22) Filed: Aug. 20, 2021

Related U.S. Application Data
(60) Provisional application No. 63/068,701, filed on Aug. 21, 2020.

(51) Int. Cl. A21C 11/10; A21C 9/08; A21C 13/00; A21C 3/00

(52) U.S. Cl. CPC A21C 11/10; A21C 3/00; A21C 13/00; A21C 9/081

(57) ABSTRACT

An apparatus (e.g., a conveyor system) configured to transport dough through a plurality of substations as described herein. The plurality of substations provides for the handling (e.g., cut, shape, flatten, proof, etc.) of the dough, which has been fermented for eighteen to twenty hours before beginning the baking process, without excess flouring.

### CROSS REFERENCE TO RELATED APPLICATIONS

This application claims priority to U.S. Provisional Patent Application No. 63/068,701, filed Aug. 21, 2020, the subject matter of which is incorporated herein by reference in entirety.

### FIELD OF THE DISCLOSURE

Aspects of the disclosure relate to mass producing bread sticks.

### BACKGROUND

In the production of bakery product, and in particular in the production of bread, a dough is prepared which dough undergoes a large number of process steps until the final bakery product is obtained. Examples of such process steps are, dough sheeting, dividing of the dough in individual dough pieces, forming the dough pieces in a desired shape, proofing, molding, final proofing, baking, cooling, and packing. Accordingly, the production of bakery product usually requires an assembly line of different production apparatuses, and many transfers of the dough or of the dough pieces between said apparatuses. Usually, each of said apparatuses includes dedicated carriers for conveying the dough or dough pieces through said apparatus, and the dough or dough pieces need to be transferred between different carriers in the assembly.

Such transfers are restrictive because they require handling of the products themselves, either in the form of the dough or dough pieces, before baking, or in the form of baked or prebaked bakery products after baking, at different stages of the manufacturing process. The handling is difficult, especially upstream of the oven. In addition, because of the stickiness of the dough, these transfers, and the handling of the dough or dough pieces generate product degradation.

In order to substantially prevent the dough from sticking to components of the apparatus and/or carriers in the assembly for the industrial manufacture of bakery products, such components and/or carriers can be provided with a non-stick coating. Modern coatings provide a high resistance to abrasion, chemicals, and corrosion, and ensure a long lifespan of the components and/or carriers. However, in the long run, used components and/or carriers need to be replaced with new ones, or need to be re-coated.

In addition or alternatively, the dough or dough pieces, and/or the components and/or carriers in the assembly for the industrial manufacture of bakery products are floured abundantly. There are at least three major disadvantages to the flouring, especially in the field of industrial production of bakery products: excessive flour on the carrier for dough pieces constitutes a thermal insulator, and limits the heat exchange between the carrier and the bottom of a dough piece, which may negatively impact the quality of the crust on the bottom of the finished product; flouring may give rise to pollution throughout an industrial production circuit, and in particular, flouring and flour dust in suspension in the air may increase the risk of catching fire; and fouling of the rising and/or baking carriers or supports as a result of flouring requires workers to wash and dry said carriers or supports frequently.

### SUMMARY

The aforementioned production issues are only exacerbated by the increased time required for fermentation of the dough. For example, if dough is created during the production process, the dough must be fermented through a fermentation process. Fermentation refers to the chemical decomposition of complex organic compounds into simpler substances. With bread, this refers to the process by which yeast converts sugar to carbon dioxide and alcohol in the absence of oxygen, causing dough to rise.

In conventional productions systems, dough is fermented for no more than one to three hours. However, through the production methods discussed herein, the fermentation time may be expanded to eighteen to twenty hours before beginning the baking process. In effect, this greatly helps to break down the gluten fibers in the flour, and to develop enhanced, robust flavor in the finished bread. As an additional benefit, the longer fermentation process allows for more time to break down starch molecules into sugar, and also break up the gluten protein in the dough. This allows the resulting bread products to have a lower gluten level for consumers who are sensitive to gluten.

In some aspects, the methods and system describe the use of an apparatus that transports dough through a plurality of substations as described herein. The plurality of substations provide for the handling of the dough, which has been fermented for eighteen to twenty hours before beginning the baking process, without excess flouring.

Various other aspects, features, and advantages of the invention will be apparent through the detailed description of the invention, and the drawings attached hereto. It is also to be understood that both the foregoing general description, and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative conveyor system, in accordance with one or more example embodiments.

FIG. 2 shows a first substation on an illustrative conveyor system, in accordance with one or more example embodiments.

FIG. 3 shows a second substation on an illustrative conveyor system, in accordance with one or more example embodiments.

FIG. 4 shows a third substation on an illustrative conveyor system, in accordance with one or more example embodiments.

FIG. 5 shows a fourth substation on an illustrative conveyor system, in accordance with one or more example embodiments.

FIG. 6 shows a fifth substation on an illustrative conveyor system, in accordance with one or more example embodiments.

FIG. 7 shows a sixth substation on an illustrative conveyor system, in accordance with one or more example embodiments.

FIG. 8 shows a seventh substation on an illustrative conveyor system, in accordance with one or more example embodiments.

### DETAILED DESCRIPTION OF THE DRAWINGS

In the following description, for the purposes of explanation, numerous specific details of some examples are set forth in order to provide a thorough understanding. It will be appreciated, however, by those having skill in the art that the embodiments may be practiced without these specific details, or with an equivalent arrangement. In other cases, well-known structures and devices are shown in block diagram form in order to avoid unnecessarily obscuring the embodiments of the invention. It should also be noted that the operations and functions of one or more of the substations described below may be performed by one or more other substations, resulting in more or less substations throughout the system.

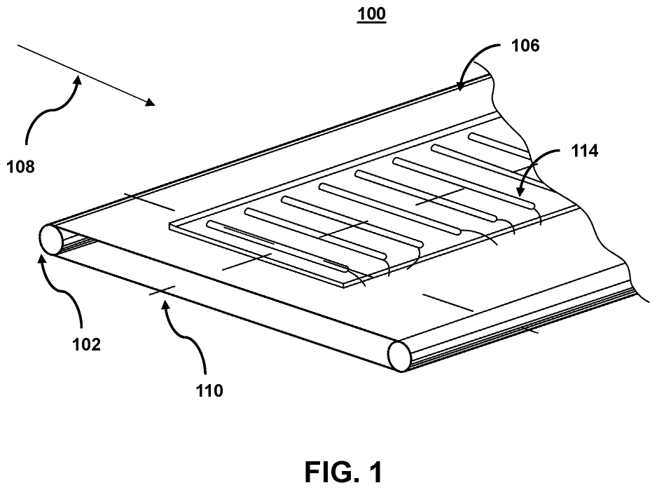

FIG. 1 shows an illustrative conveyor system, in accordance with one or more example embodiments. FIG. 1 shows a first example of system 100 for the industrial manufacture of bakery products, such as long or elongated breads, rolls, baguettes, Parisian breads, round loaves and, in particular, Corsica bread sticks. System 100 comprises conveyor 102 for conveying at least one piece of dough on conveying surface 106 in conveying direction 108. Conveyor 102 comprises conveyor belt 110 which is arranged around return rollers 112, wherein conveyor belt 110 provides conveying surface 106. Conveyor belt 110 may be sufficiently rigid for carrying the pieces of dough 104 and/or a pan holding dough, substantially without sagging between return rollers 112. Alternatively or additionally, carrying member 114 may be arranged to provide a rigid support for the upper branch of conveyor 102. Conveyor 102 may transport dough 102 to a mixing unit, and conveyor 102 is positioned to receive a succession of the batches of dough 102 discharged from a dough mixing unit. The pan may include a custom texturing. For example, the proper surface contour/texturing of the pan allows for the oils to circulate beneath the bread, in order to attain adequate exposure, while the contractions during cooling draw the oils upward into the bread.

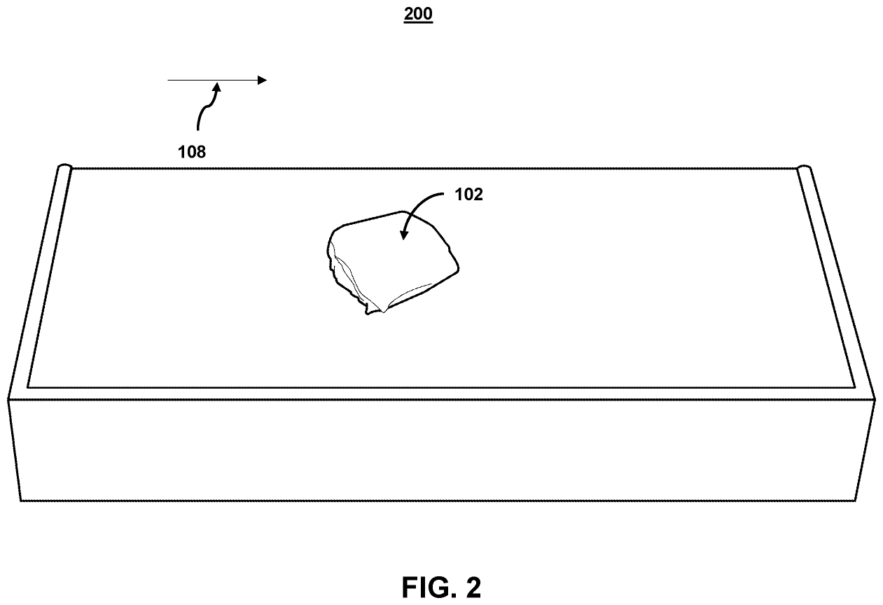

FIG. 2 shows a first substation on an illustrative conveyor system, in accordance with one or more example embodiments. At first substation 200, dough 102 is evenly shaped and flattened. For example, the initial dough pile may be flattened on granite with a (yellow) nylon sheet-pan, using a sheeter-roller. First substation 200 may then trim the dough pile into four straight edges.

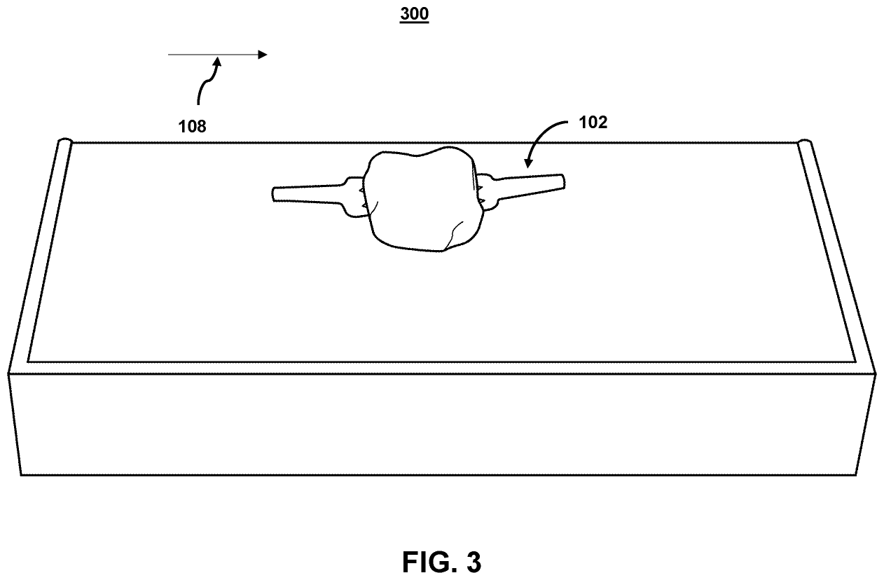

FIG. 3 shows a second substation on an illustrative conveyor system, in accordance with one or more example embodiments. At second substation 200, dough 102 is scored/marked into rectangles (e.g., approximately 14″×5″) over the entire trimmed dough pile of dough 102 on the granite. Second substation 200 may then cut-out one rectangle at a time and cradle it onto a bread scale set for 6 lb., where the dough-weight is adjusted as needed. Second substation 200 may then form an initial shape-n-slap rectangle on the bread table, and set dough 102 aside to rest (e.g., for seven minutes). Second substation 200 may then shape-n-slap each rectangle again and allow for a second rest time (e.g., for five minutes). Second substation 200 (or other substation) may prep all of the bake-pans with an oil base (e.g., a “#2”—baked&strained oil only) and without the use of Teflon paper.

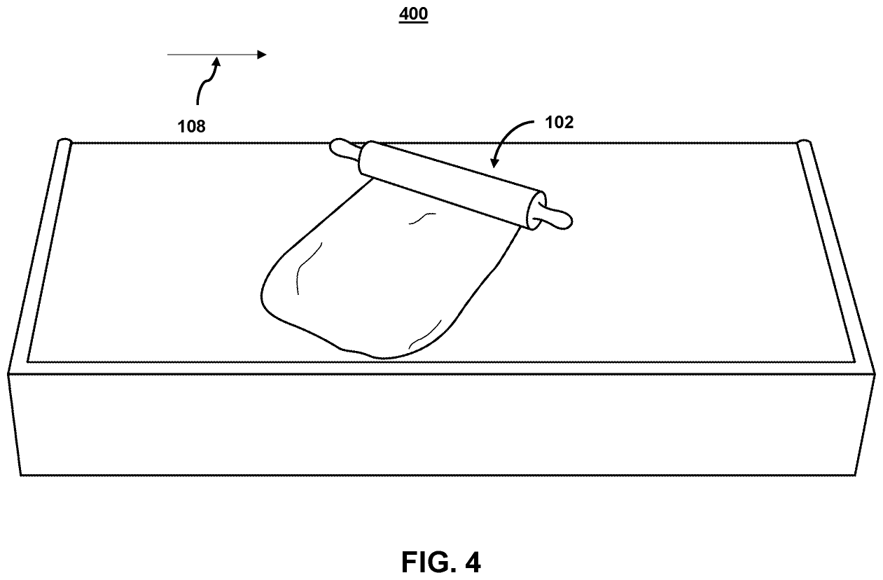

FIG. 4 shows a third substation on an illustrative conveyor system, in accordance with one or more example embodiments. At third substation 400, dough 102 has another shape-n-slap-n-shape into an approximate 18″×11″ rectangle. Third substation 300 may then press down the form easily with the sheet-pan, and/or use a rolling pin (or similar mechanism) to evenly flatten.

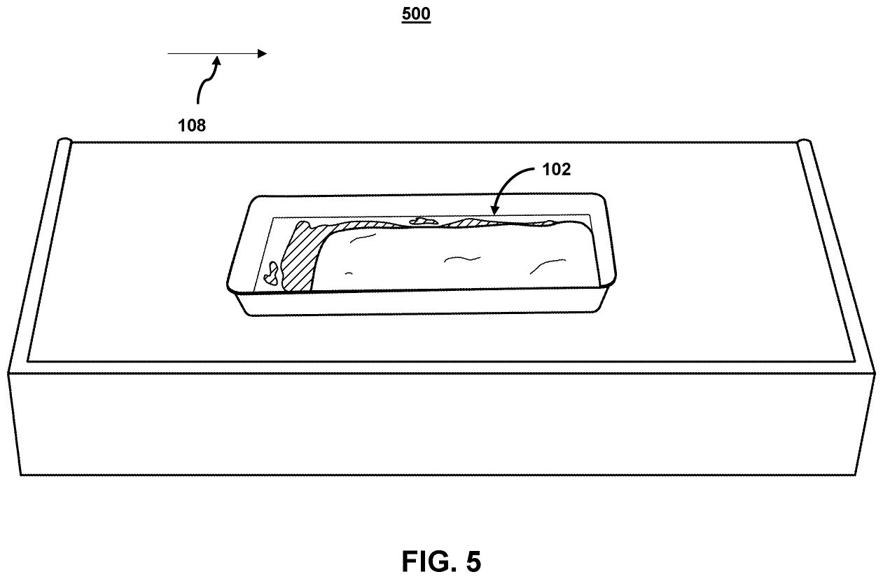

FIG. 5 shows a fourth substation on an illustrative conveyor system, in accordance with one or more example embodiments. At fourth substation 500, dough 102 is moved into pan. Dough 102 is folded end to end in thirds, and then cradled with two table blades so as not to leave impressions (e.g., finger or mechanical indents) in the bottom. Fourth substation 400 then folds dough 102 open longwise in pan.

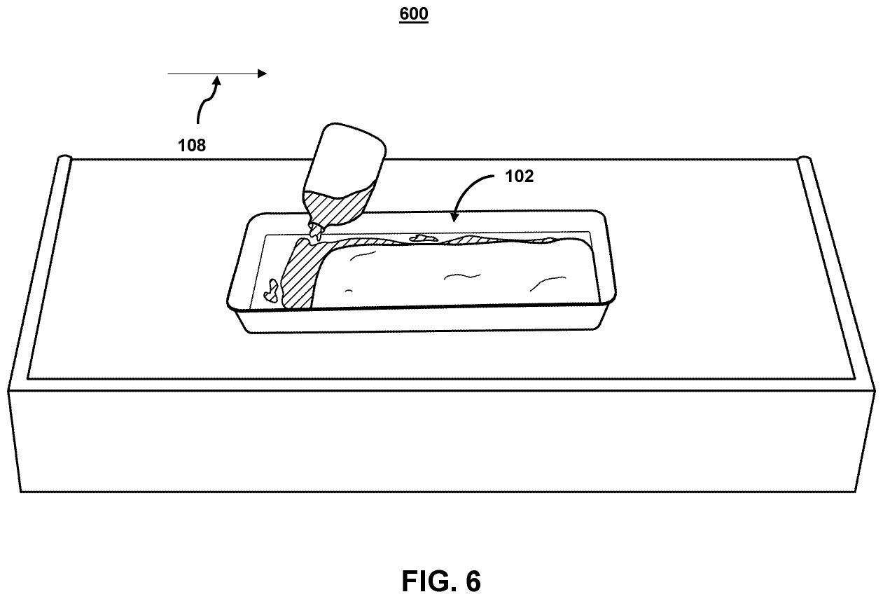

FIG. 6 shows a fifth substation on an illustrative conveyor system, in accordance with one or more example embodiments. At fifth substation 600, dough 102 is dressed generously with an oil mix (e.g., “#3”—fully blended oil mix).

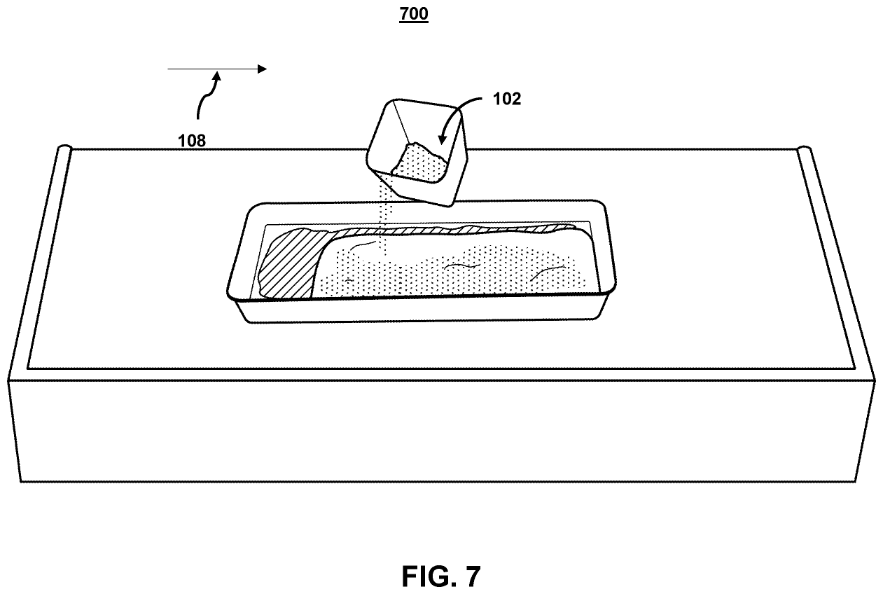

FIG. 7 shows a sixth substation on an illustrative conveyor system, in accordance with one or more example embodiments. At sixth substation 700, sixth substation 700 seeds-n-pats dough 102 generously with raw sesame seeds. Sixth substation 700 measures and marks each loaf longwise at 8 sticks wide. Sixth substation 700 then fully scores dough 102 through, nearly end to end. Sixth substation 700 dockers down, and then press-perforates thoroughly dough 102. Sixth substation 700 then adds touch-up dressing with sesame seed-n-pat where needed. At this point, dough 102 now nearly fills the entire pan to within 1″ of the edge.

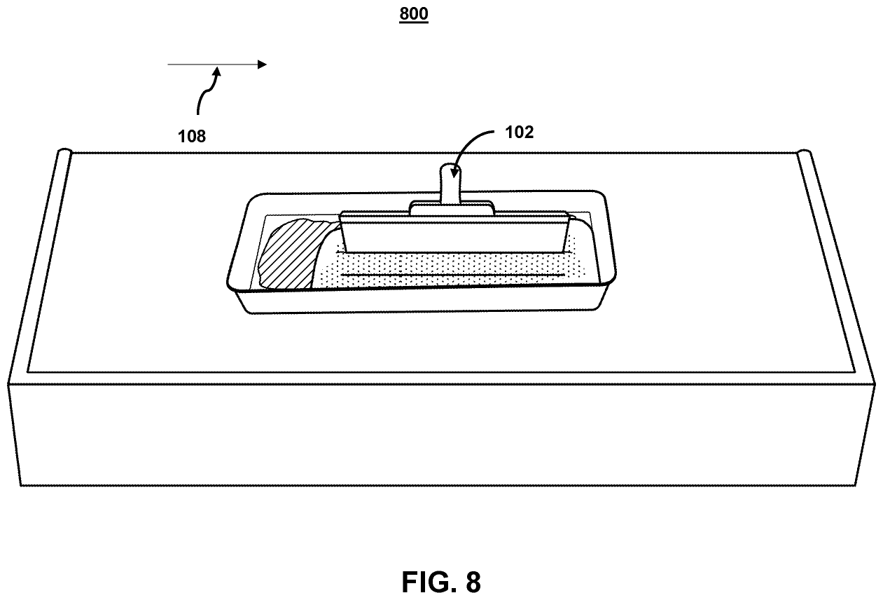

FIG. 8 shows a seventh substation on an illustrative conveyor system, in accordance with one or more example embodiments. At seventh substation 800, seventh substation 800 proofs all dough together for twenty to thirty minutes. Seventh substation 800 may, for a full six-pan bake, retard all six for ten to fifteen minutes in a cooler first, in order to stabilize. Seventh substation 800 may then proof dough together for approximately twenty to thirty minutes.

System 100 may further comprise a heating device. The heating device, or oven unit, may comprise an electrical, gas, or other type of heating device. System 100 may then transport dough 102 to a heating device. An oven conveyor may have a plurality of dough holders spaced apart from each other. Each dough holder is configured to contain a single batch of dough. The oven conveyor has a portion adjacent to the discharge portion of the dough transport and is configured to sequentially move the dough holders through a position to receive a single batch of dough from the discharge portion of the dough transport. An oven unit is coupled to conveyor 102 and has an oven inlet, an oven outlet, a baking portion, a prebaking portion, and a pathway extending through the prebaking and baking portions. At least a portion of conveyor 102 extends through the oven unit along the pathway. The oven unit has a heat diffuser adjacent to the baking portion to shield at least a portion of the prebaking portion and the dough holders from heat applied to the baking portion. The oven conveyor is configured to move the dough holders through the baking portion at a rate so the single batches of dough in the dough holders will be sequentially baked to form the baked products when the dough holder exit the oven unit. In some embodiments, conveyor 102 may transport dough 102 in a pan.

Upon removal from the oven conveyor, an annealing process begins. For example, the oil-blend is drawn up into the bread. Conveyor 102 may then cut the well-scored bread sticks are all cut thoroughly apart again. As the pan with dough 102 (now baked bread) is cooling, approximately 18 oz. of the bake-oil already present in the pan is facilitated and permitted to be absorbed into the bottom crust of the baked sticks. Upon a total product weight of 7.35 lb. is achieved, dough 102 (e.g., now bread sticks) are removed from the oil-bath and placed onto a flat dry pan in order to finish cooling.

After a predetermined time has passed for dough 102 become fully finished or “set”, (a minimum time of 6 hrs. at rest), then each individual set dough 102 is sliced cross-wise into ¼″ slices. Next, the ¼″ slices are evenly scattered onto standard baking aluminum full-sheet pans, at a density volume of 5+ fully-sliced, set dough 102 (approximately 2.75 lb.) per sheet-pan. The set, sliced dough 102 morsels are then baked @ 285F for a total bake-time of 30 minutes. Again, as within the first bake, all relevant day-to-day nuances must be thoroughly addressed during the baking process in order to ensure professional results. Finally, the product is removed from the pans from the oven and allow the baked morsels to thoroughly cool.

Once the baked morsels have assumed room temperature, now being handled as fragile, the bread sticks are transported down conveyor 102 for packaging. If packaging is scheduled to occur at some later point in time, the morsels will be best stored in sealed mid-size culinary Cambro containers, -stored in a walk-in cooler, or some other suitably dark, cool and dry place.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. An apparatus for transporting dough that is fermented for a specified period of time, the apparatus comprising:
a plurality of substations configured to handle the fermented dough, the plurality of substations comprising:
a first substation configured to shape, flatten and trim the dough;
a second substation configured to receive the dough from the first substation, the second substation configured to mark shapes on the dough, cut-out the shapes, set the dough aside to rest for a first time period, and prepare bake pans with an oil base;
a third substation configured to receive the cut-out dough from the second substation and press down the cut-out dough;
a fourth substation configured to receive the pressed down dough from the third substation and move the pressed down dough into a pan;
a fifth substation configured to receive the pressed down dough in the pan and dress the dough with an oil mix;
a sixth substation configured to receive the dough with oil mix from the fifth substation and seed-n-pat the dough with seeds; and
a seventh substation configured to receive the dough with the seeds from sixth substation and proof the dough for a second time period.
